(19) United States
(12) Patent Application Publication
(10) Pub. No.: US 2005/0110843 A1
(43) Pub. Date: May 26, 2005

(54) Ink feed system for ink-jet printers and method for pouring the ink into said feed system

(75) Inventor: Paolo Capano, Varese (IT)

Correspondence Address: HOGAN & HARTSON LLP;IP GROUP, COLUMBIA SQUARE, 555 THIRTEENTH STREET, N.W., WASHINGTON, DC, 20004, US

(73) Assignee: ANTEPRIMA S.r.1.

(21) Appl. No.: 10/717,920

(22) Filed: Nov. 21, 2003

(30) Foreign Application Priority Data
Nov. 21, 2003 (IT) MI2003A001153

(51) Int. Cl. B41J 2/175

(52) U.S. Cl. 347/85

(57) ABSTRACT

A gravity ink feed system for ink-jet printers comprises a reservoir chamber, a feed chamber, connected to printing heads, and a duct provided with an opening to the atmosphere, with a first port for connection to the feed chamber and with a second port for connection to the reservoir chamber. The feed system is rotatable from a first configuration suitable for normal feeding of the ink, to a rotated configuration suitable for topping up the ink. Support means for said feed systems are suitable for producing a modular support structure, suitable for supporting one or more feed systems, for example each relating to an ink of a different colour.

### FIELD OF THE INVENTION

The subject of the present invention is an ink feed system for ink-jet printers and a method for pouring the ink into said feed system.

### BACKGROUND OF THE INVENTION

Said ink feed system is intended to be used in particular, but not solely, in professional type printers, suitable for executing prints of large dimensions, for example on wall posters, fabrics, or coverings for goods transport vehicles.

It is known in the field that the prints executed with ink-jet printers exhibit a good quality of execution, for example lines devoid of smudging, uniform colours, and the like, when the ink feed pressure to the printing heads is kept constant or in any case variable within narrow limits.

Some solutions of the prior art, in order to keep said feed pressure constant, use systems controlled electronically or using spring devices.

Systems which have proved to be particularly efficient, however, besides being particularly simple to construct, assembly and maintain, are gravity ink feed systems, in which the ink travels from the reservoir to the feed chamber connected to the heads simply by the effect of the force of gravity.

In such feed systems, the ink feed pressure to the heads is kept constant by keeping constant the difference in level between the port for feeding ink to the heads and the free surface of the ink, or the surface of the liquid exposed to the atmosphere, in the feed chamber or in the reservoir.

An embodiment according to what has been stated above is described, for example, in the document EP-A1-0999059.

Such solutions, however, have the drawback of having to make provision, when the ink in the reservoir is exhausted, for substitution of the exhausted container by a full container or for topping-up of the container, which leads to disturbance of the ink conditions in the feed chamber, causing unwanted variation of the conditions under which the ink is fed to the heads.

The problem underlying the present invention is that of devising an ink feed system for ink-jet printers which has structural and functional characteristics such as to satisfy the aforesaid requirements and at the same time to remedy the drawbacks mentioned with reference to the prior art.

### SUMMARY OF THE INVENTION

This problem is solved by an ink feed system according to claim 1 and by a method for pouring said ink into said feed system according to claim 17. Further embodiments of the invention and further forms of execution of the method are described in the claims respectively dependent thereupon.

### BRIEF DESCRIPTION OF THE DRAWINGS

Further characteristics and advantages of the feed system and of the method for pouring ink according to the present invention will become clear from the following description of a preferred, non-limiting exemplary embodiment, in which

FIG. 1a shows a diagrammatic view of a feed system in a first configuration for normal feeding of the ink;

FIG. 1b shows the feed system of FIG. 1a in a second configuration for pouring the ink;

FIGS. 2 and 3 respectively represent an axonometric view and a plan view of a further alternative embodiment of the feed system, in which a portion of the case is removed to show the inside thereof;

FIG. 4 shows an apparatus for feeding the ink comprising a feed system;

FIG. 5 shows an enlarged detail of the apparatus of FIG. 4;

FIG. 6 shows an exploded axonometric view of a further preferred embodiment of the feed system associated with support means;

FIG. 7 shows the feed system of FIG. 6 in association with the support means according to an assembly arrangement;

FIG. 8 shows an assembly arrangement for the support means;

FIGS. 9, 10 and 11 show feed apparatus comprising said feed system.

### DETAILED DESCRIPTION OF THE INVENTION

With reference to the appended drawings, 1 indicates as a whole an ink feed system for ink-jet printers.

The feed system 1 comprises a reservoir chamber 2, intended to contain the ink, and a feed chamber 4, fluidly connected to printing heads of said printer (not shown) and fluidly connected to said reservoir chamber 2.

In particular, said feed chamber 4 has an outflow port 6 fluidly connected to said printing heads.

The feed system 1 further provides a duct 10 provided with an opening 12 to the atmosphere.

Said duct 10 further has a first port 14 for connection to the feed chamber 4 and a second port 16 for connection to the reservoir chamber 2.

Other than through said second port 16 of the duct 10, said reservoir chamber 2 is impermeable to fluids.

In other words, the reservoir chamber 2 has a single opening, coinciding in particular with said second port 16 of the duct 10 open to the atmosphere, while said feed chamber 4, besides said outflow port 6 to the printing heads, has an opening coinciding with said first port 14 of the duct 10.

The feed system 1 is contained, in a preferred embodiment, in a case 18, rigid at least in the portion which bounds the reservoir chamber 2.

Said case 18 comprises an annular wall 18a and lateral walls, that can preferably be associated with sealing means, for example a gasket 18b, which close it to define a case that is closed other than through the aforesaid openings.

In other words, the reservoir chamber 2, the feed chamber 4 and the duct 10 are contained within the case 18. Said case 18 has two openings towards the inside, corresponding to said opening 12 to the atmosphere of the duct 10 and to said outflow port 6 of the feed chamber 4.

Inside said case 18, inner walls are provided, suitable for defining the reservoir chamber 2, the feed chamber 4 and the duct 10.

In particular, a first inner wall 28 and a second inner wall 30 are provided, projecting internally from the case 18 so as to converge with one another.

The first inner wall 28 has a free end 28a and the second inner wall 30 has a free end 30a.

Said second port 16 of the duct 10, or the opening of the reservoir chamber 2 opens between said free ends 28a, 30a.

Said first port 14 of the duct 10, or the connecting opening between the feed chamber 4, the duct 10 and the reservoir chamber 2, opens between the free end 28a of the first inner wall 28 and the annular wall 18a of the case 18.

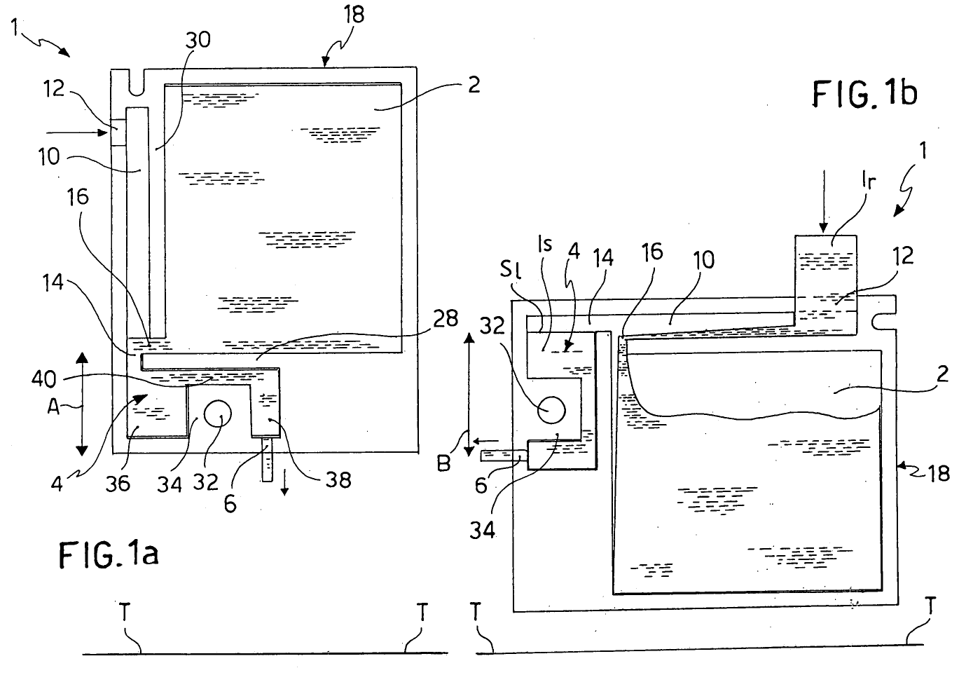

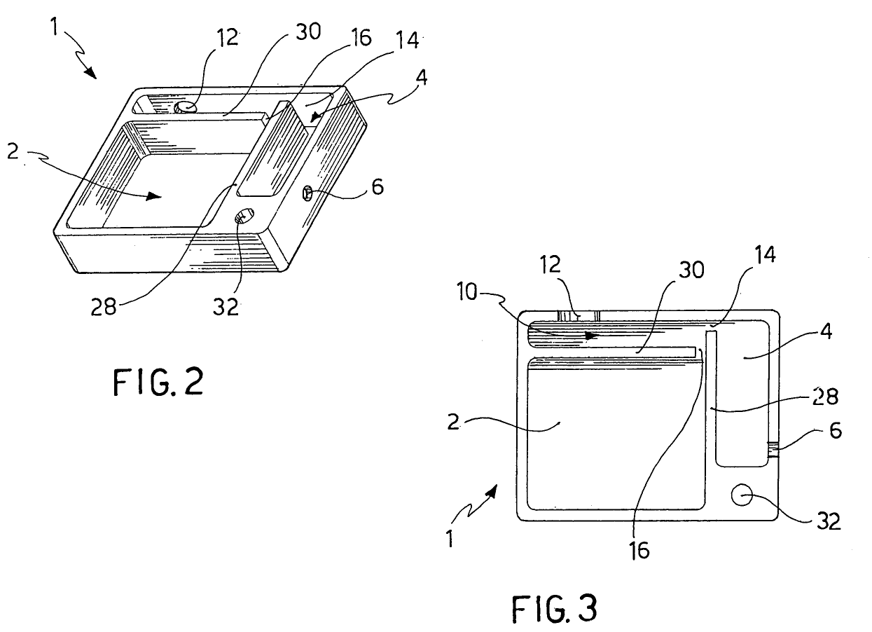

Furthermore, said feed system 1 has a hinge 32 which permits the rotation of said case 18 between a first configuration for normal feeding of the ink to the printing heads (FIG. 1a) and a second configuration for pouring the ink into the reservoir chamber 2 (FIG. 1b).

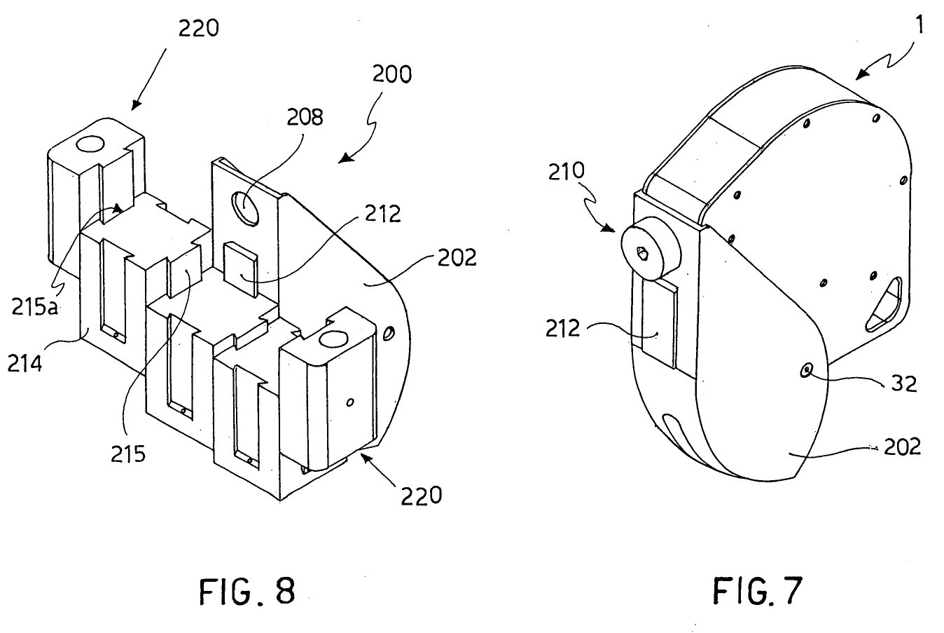

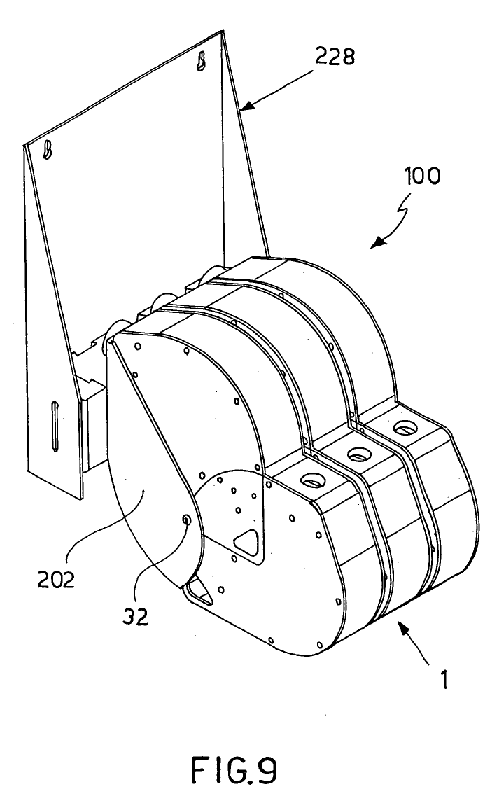

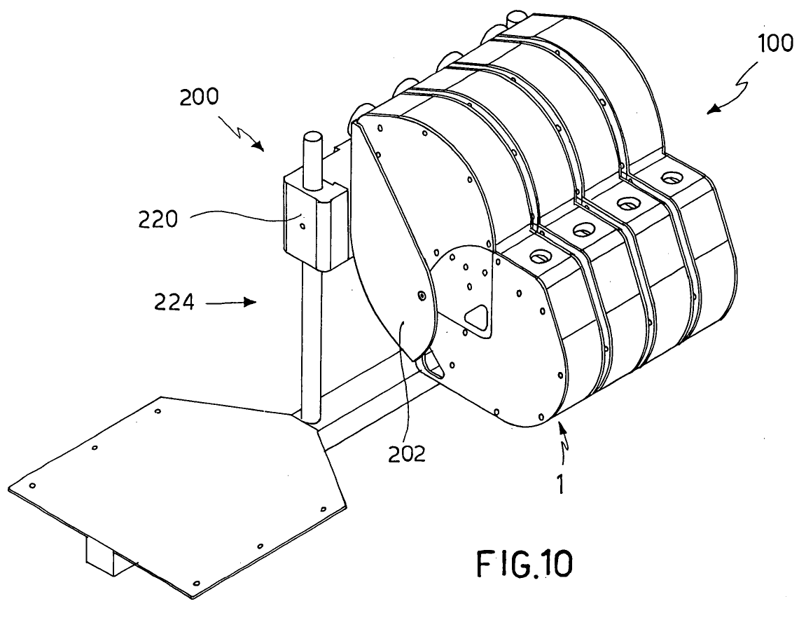

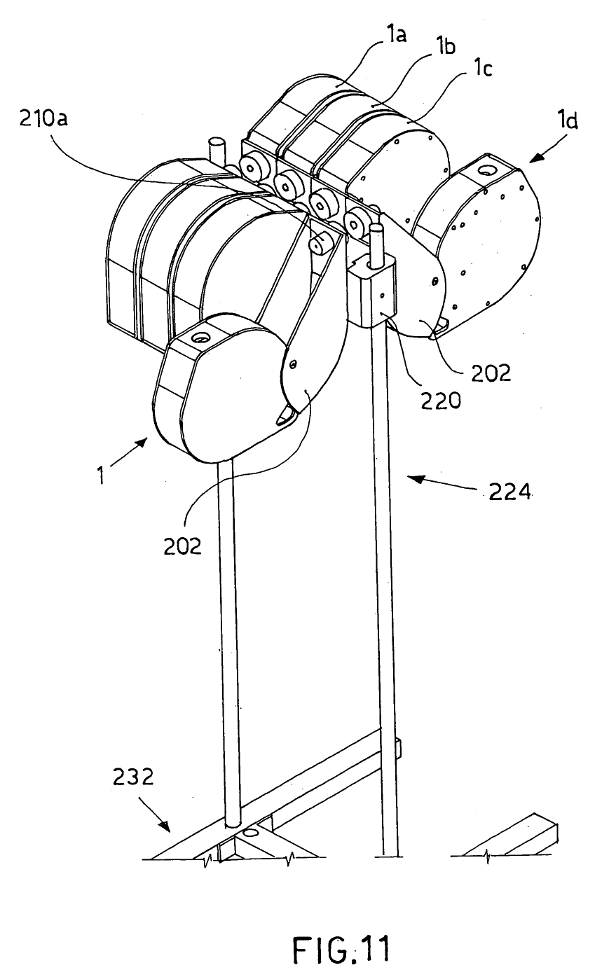

In a preferred embodiment, said case 18 is substantially cylindrical in shape (FIGS. 6 to 11).

A first member 19a and a second member 19b protrude from said annular wall 18a.

Said member 19a, provided with flat walls extending from said annular wall 18a of the case 18, is perforated, producing said opening to the atmosphere 12.

Advantageously, said first member 19a reinforces the annular wall 18a of the case 18 at said opening to the atmosphere 12 and is suitable for providing, for said opening to the atmosphere 12, an entrance on a flat wall, inclined as required with respect to said annular wall 18a.

The second member 19b, provided with flat walls extending from said annular wall 18a of the case 18, comprises gripping means suitable for gripping said case, for example with one hand.

Furthermore, said second member 19b provides for said hinge 32 about which said system is rotatable.

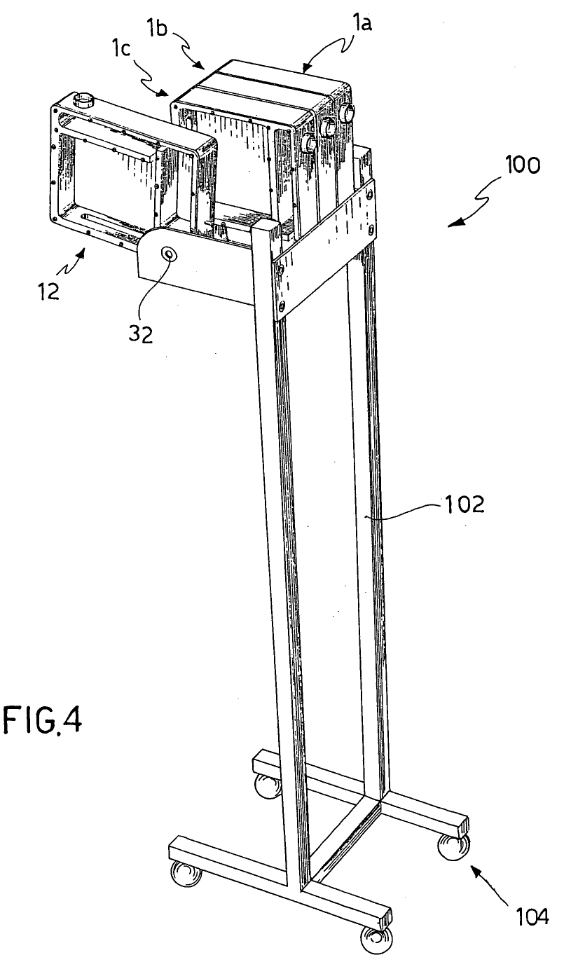

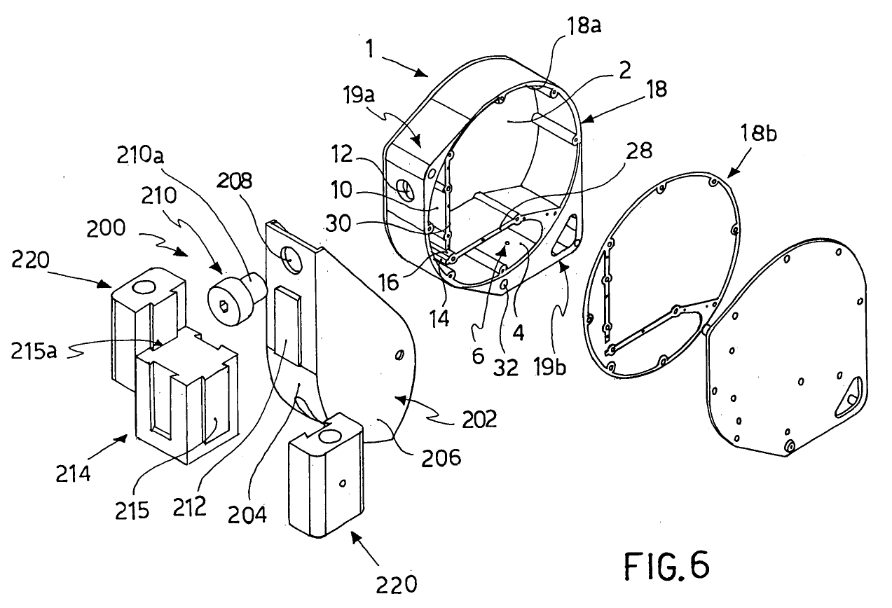

In a further alternative embodiment, said case 18 is box-shaped, and in particular is configured as a parallelepiped (FIGS. 2 to 5).

Preferably, said hinge 32 is contained in the feed chamber 4 for the ink. For example, the annular wall 18a of the case 18 has an inner raised portion 34, contained in said feed chamber, and through which said hinge 32 is provided.

In particular, the raised portion 34 is suitable for forming in the feed chamber 4 a reserve chamber 36 and a residual chamber 38, which are connected by a passage 40, defined between said raised portion 34 and said first inner wall 28.

The reserve chamber 36 communicates with the reservoir chamber 2 and the duct 10 via said first port 14, and said residual chamber 38 communicates with the printing heads via said outflow port 6.

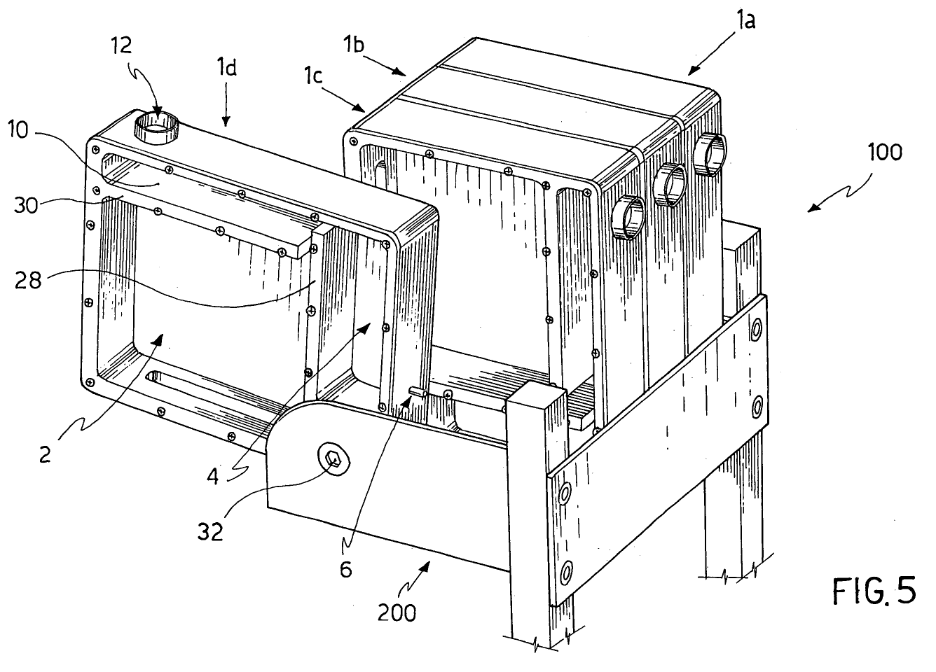

An apparatus 100 for feeding the ink to ink-jet printers comprises one or more feed systems 1 (FIGS. 4, 5 and 9, 10 and 11).

Said apparatus 100 further comprises support means 200 suitable for supporting said feed system 1 at a predetermined level with respect to a reference plane.

According to a preferred embodiment, said support means 200 comprise an intermediate member 202 suitable for at least partially housing said case 18.

For example, said intermediate member 202 comprises a front wall 204 and lateral walls 206 spaced in such a way that between said walls a seat is produced in which said case can be at least partially housed.

The case 18 can be associated with said intermediate member via said hinge 32.

Preferably, the intermediate member 202 is provided with a hole 208 that can be associated with a retaining member 210. For example, said retaining member 210 is a perforated member, made of plastics or elastomeric material, suitable for insertion into said hole 208 with a portion 210a thereof. Said portion 210a is suitable for co-operating with an interference fit with the opening to the atmosphere 12 of the feed system 1, retaining said system in the configuration for normal operation.

Said hole 208 and said retaining member 210 provide a preferred example of locking means for locking the feed system in the configuration for normal operation.

Furthermore, said intermediate member 202 is provided with coupling means, comprising a geometric coupling member 212, for example a dovetail member.

Said support means 200 further comprise one or more stirrups 214 suitable for co-operating with the feed system 1 for supporting the latter. For example, said stirrup 214 comprises a seat suitable for coupling to said dovetail member 212 of the intermediate member 202.

The stirrup 214 is suitable for producing a modular structure comprising a plurality of said stirrups 214, for the support of a plurality of feed systems.

In other words, said stirrups 214 are suitable for being connected with one another, for example at portions thereof that are not intended to be associated with said intermediate member 202, in order to produce a support structure suitable for supporting a plurality of feed systems 1.

Said stirrups 214 have a non-symmetrical configuration with respect to at least one plane passing through the centre line of said stirrups.

For example, said stirrup 214 provides on a first lateral surface, intended for connection to a further stirrup, a protruding member 215, preferably a dovetail member, and, on a second lateral surface, also intended for connection to a further stirrup and opposed to the first, a pocket 215a, for example of the dovetail type.

Said pocket 215a is suitable for receiving a protruding member 215 of a similar stirrup 214, in order to produce said modular support structure.

Said stirrups are further associable with terminal closure members 220, suitable for engaging with said stirrups and of co-operating with a frame 224.

Preferably, said terminal closure members are associable with said frame so that the level with respect to the reference plane is adjustable.

In further alternative embodiments, said support means 200 comprise a support plate 228.

Furthermore, in an alternative embodiment, said support means 200 comprise a trolley 232, preferably displaceable, comprising said frame 224.

The feed systems 1 are connected in operation to said apparatus 100 so as to permit rotation of said systems between said first configuration for normal feeding of the ink (systems 1a, 1b, 1c in FIGS. 4 and 11) and said second configuration for pouring the ink (system 1d in FIGS. 4 and 11).

Preferably, said feed systems are connected to said apparatus 100 so that said rotation is permitted independently for one feed system with respect to another.

In order better to illustrate the operation of the feed system, a horizontal reference plane T-T is defined, for example coinciding with the floor of the premises in which the ink feed apparatus is used (FIGS. 1a and 1b).

Relative to said reference plane T-T, there are understood to be defined the terms “higher” and “lower” used hereinafter.

In normal operation of the feed system 1, the reservoir chamber is disposed higher than the feed chamber 4 (FIG. 1a).

The ink in the reservoir chamber 2 flows through the second port 16 and the first port 14 towards the feed chamber 4 and from the latter, through the outflow port 6, towards the printing heads.

The duct 10 open to the atmosphere owing to the opening 12 permits the passage of air to the inside of the reservoir chamber 2 through the second port 16, compensating for the outflow of ink from said reservoir chamber 2.

At the same time, the duct 10 maintains the ink in proximity to the first port 14 at a pressure substantially equal to atmospheric pressure.

The pressure at which the ink is fed to the printing heads is substantially influenced by the difference in level A, first port/outflow port, with respect to the reference plane T-T, between the level of the first port 14 and the level of the outflow port 6.

When required, it is necessary to pour topping-up ink Ir into the reservoir chamber 2.

From said first configuration for normal feeding of the ink, said feed system 1 is rotatable into the second configuration suitable for pouring topping-up ink into the reservoir chamber 2 (FIG. 1b).

In said second configuration, the second port 16 of the duct 10, or the opening of the reservoir chamber 2, provides a passage for the ink that is not parallel to the reference plane T-T.

The topping-up ink is introduced by the opening 12 of the duct and flows along the duct 10, bounded by said second inner wall 30, until it meets said second port 16 which, by providing a passage for the ink that is not parallel to the reference plane T-T, allows the topping-up ink to enter the reservoir chamber 2.

In other words, the second port 16, which intercepts the flow of topping-up ink, conveying it towards the reservoir chamber 2, is disposed between the first port 14 of the duct 10, or the opening of the feed chamber 14, and the opening 12 to the atmosphere.

Again in other words, the topping-up ink Ir follows a topping-up path, defined by the duct 10 and by the second port 16, and separate from the feed chamber 4, since said topping-up ink is intercepted by said second port 16 before passing through the first port 14 for communication with the feed chamber 4.

At the same time, reserve ink Is contained in the feed chamber 14 also in the configuration for pouring the topping-up ink, owing to the first inner wall 28 which bounds said feed chamber 4, continues to feed the printing heads.

The feed pressure is substantially influenced by the difference in level B, with respect to the reference plane T-T, between the free surface S1 of the reserve ink Is, substantially maintained at atmospheric pressure and defined by the level of the free end 28a of the first inner wall 28, and the level of the outflow port 6.

In a preferred embodiment, the feed system 1 provides for said difference in level B between the free end 28a of the first inner wall 28 and the level of the outflow port 6 in the second configuration to be equal to said difference in level A between the level of the first port 14 and the level of the outflow port 6 in the first configuration.

Advantageously, at least at the start of the operations of pouring the topping-up ink, the ink feed pressure to the heads is substantially equal to the feed pressure in the course of normal operation.

The hinge point of the feed system 1, coinciding for example with the position of the hinge 32, is advantageously disposed in proximity to the outflow port 6 to which the printing heads are connected.

In passing from the first configuration of operation to the second, the position of said outflow port varies to a limited extent.

In other words, the level of the outflow port 6 with respect to the reference plane T-T in the configuration for normal operation is substantially equal to the level of the outflow port 6 in the configuration for pouring the ink.

Unusually, the ink feed system for ink-jet printers according to the invention makes it possible to pour topping-up ink into the reservoir chamber, avoiding the substitution of ink containers, and to carry out pouring in such a way as not to disturb the conditions under which the ink is fed to the printing heads.

In other words, in the course of pouring ink into the reservoir chamber, the ink is fed to the heads from the feed chamber in which the reserve ink is not disturbed by said pouring operation.

Again in other words, providing said duct open to the atmosphere communicating via separate ports with the feed chamber and the reservoir chamber makes it possible, in the second configuration, to separate the topping-up path from the feed chamber itself, while maintaining the free surface of the reserve ink contained in said chamber at atmospheric pressure.

Furthermore, in the course of pouring, the ink is advantageously fed at a pressure which is substantially constant or variable within narrow limits.

Furthermore, the system has a structure which is simple but extremely efficient in use, permitting the ink to flow into the reservoir chamber through the same single opening of said reservoir chamber from which, in normal operation, the ink flows to the feed chamber.

According to a further advantageous feature, the topping-up ink is introduced into the case through the duct which, in normal operation of the system, allows the air to be introduced into the reservoir chamber and the ink in the feed chamber to maintain a free surface substantially at atmospheric pressure.

According to yet a further advantageous feature, the modular type support means make it possible to produce an apparatus suitable for satisfying different requirements according to the number of feed systems required.

In other words, by using one or more stirrups, it is possible to equip said apparatus, according to the user's requirements, with one or more cases, each containing, for example, an ink of a different colour.

Finally, according to yet a further advantageous feature, in the configuration for pouring the ink, the opening of the duct is in an easy position for the user, suitable for rapid and convenient topping-up of the ink.

It is clear that an expert in the field may apply numerous modifications and variants to the invention described above, all however to be regarded as contained within the scope of teaching as defined by the following claims.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosure of all applications, patents and publications, cited therein and of corresponding Italian Application No. MI2003A001153, filed Jun. 6, 2003, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. An ink feed system for ink-jet printers, comprising
a reservoir chamber,
a feed chamber, fluidly connected to printing heads of said printer and to said reservoir chamber, said reservoir chamber, in a configuration for normal feeding of the ink to said heads, being disposed higher than said feed chamber,
said system further providing a duct provided with an opening to the atmosphere and with a first port for fluid connection to the feed chamber,
said feed system being wherein said duct is further provided with a second port for fluid connection to the reservoir chamber, said reservoir chamber being otherwise impermeable to fluids.

2. An ink feed system according to claim 1, suitable for assuming a first configuration for normal feeding of the ink and a second configuration for pouring topping-up ink into said reservoir chamber.

3. A feed system according to claim 2 wherein, in said second configuration, said second port provides a passage for the topping-up ink that is not parallel to a horizontal reference plane.

4. A feed system (1) according to claim 2 or 3 wherein, in said second configuration, said opening to the atmosphere, of the duct, is disposed higher than said second port of the duct.

5. A feed system according to claim 2 wherein, in said second configuration, said second port is disposed between said opening and said first port of the duct.

6. A feed system according to claim 2 wherein, in said second configuration, the topping-up ink flows through said duct and said second port.

7. A feed system according to claim 2, wherein said system is suitable for rotating from said first configuration to said second configuration.

8. A feed system according to claim 1, wherein said reservoir chamber, said feed chamber and said duct are contained in a single substantially rigid case.

9. A feed system according to claim 8, wherein said case is a cylindrical case.

10. A feed system according to claim 1, comprising a hinge suitable for permitting the rotation of said system.

11. A feed system according to claim 10, wherein said hinge is close to said outflow port.

12. A feed system according to claim 2 wherein, in said second configuration, said feed chamber provides a reserve chamber separate from a topping-up path by which topping-up ink flows into said reservoir chamber.

13. A feed system according to claim 12, wherein said topping-up path for the ink comprises said duct and said second port.

14. An apparatus for feeding ink to ink-jet printers, comprising one or more feed systems according to any one of the preceding claims.

15. An apparatus according to claim 14, comprising support means suitable for supporting said feed system at a predetermined level with respect to a reference plane.

16. An apparatus according to claim 15, wherein said support means comprise at least one stirrup suitable for co-operating with said feed system for the support thereof, said stirrup being suitable for producing a modular structure for the support of a plurality of feed systems.

17. A method for pouring ink into a gravity ink feed system for ink-jet printers,
said system comprising a reservoir chamber and a feed chamber,
said method comprising, in order,
the step of separating said feed chamber from a topping-up path through which topping-up ink is then introduced into said reservoir chamber;
the step of pouring said topping-up ink into said feed system.

18. A method according to claim 17, wherein the step of separating said feed chamber from said topping-up path comprises the step of rotating said feed system from a first configuration, for normal feeding of the ink, to a second configuration for pouring the topping-up ink.

19. A method according to claim 17, wherein the step of separating said feed chamber from said topping-up path provides for the step of maintaining the free surface of the reserve ink contained in said feed chamber at a pressure substantially equal to atmospheric pressure.

20. A method according to claim 17 or 18 or 19 which further provides for feeding ink to the printer simultaneously with said steps.

21. An ink feed apparatus for printers comprising:
at least one ink feed system provided with a reservoir chamber suitable for containing said ink and with an outflow port for the outflow of said ink to printing heads of said printer;
support means suitable for supporting said feed system at a predetermined level with respect to a reference plane,
wherein said support means comprise at least one stirrup suitable for co-operating with said feed system for the support thereof,
said apparatus being wherein said stirrup is suitable for producing a modular structure for the support of a plurality of feed systems.

22. An apparatus according to claim 21, wherein said stirrup has a non-symmetrical configuration with respect to at least one centre line plane.

23. An apparatus according to claim 21 or 22, wherein said stirrup has geometric couplings suitable for producing said modular structure.

24. An apparatus according to claim 21, wherein said stirrup has a pocket and a protruding member which are suitable for producing said modular structure.

25. An apparatus according to claim 21, wherein said stirrup has at least two opposed lateral surfaces for producing said modular support structure.

26. An apparatus according to claim 21, further comprising at least one terminal closure member suitable for coupling to said stirrup and to a frame of said apparatus.

27. An apparatus according to claim 26, wherein said terminal closure member is adjustable in height on said frame with respect to said reference plane.

28. An apparatus according to claim 21, wherein said support means comprise a separate intermediate member suitable for at least partially receiving said feed system and of co-operating with said stirrup of said support means.

29. An apparatus according to claim 21, wherein said support means are suitable for supporting said feed system in a configuration for normal operation and in a configuration for pouring the ink, said configuration for pouring the ink being rotated with respect to said configuration for normal operation.

30. An apparatus according to claim 29, wherein said apparatus comprises locking means for locking said feed system in said configuration for normal operation and in a said configuration for pouring the ink.
